(19) United States
(12) Patent Application Publication
(10) Pub. No.: US 2024/0251437 A1
(43) Pub. Date: Jul. 25, 2024

(54) RELIABILITY ENHANCEMENT FOR SIDELINK DISCOVERY

(71) Applicant: QUALCOMM Incorporated, San Diego, CA (US)

(72) Inventors: Kianoush HOSSEINI, San Diego, CA (US); Alberto RICO ALVARINO, San Diego, CA (US); Gabi SARKIS, San Diego, CA (US); Hong CHENG, Basking Ridge, NJ (US); Peng CHENG, Beijing (CN)

(21) Appl. No.: 18/289,851

(22) PCT Filed: May 11, 2021
(86) PCT No.: PCT/CN2021/093037

§ 371 Date: Nov. 7, 2023

(51) Int. Cl. H04W 72/566; H04W 72/40

(52) U.S. Cl. CPC H04W 72/569; H04W 72/40

(57) ABSTRACT

Certain aspects of the present disclosure provide techniques for improved sidelink discovery communication. An example method performed by a user equipment (UE) generally includes deciding, when a conflict occurs between a sidelink discovery message and at least one other transmission in a transmission period, whether to transmit the sidelink discovery message or the at least one other transmission based, at least in part, on a priority of the sidelink discovery message; and transmitting the sidelink discovery message or the at least one other transmission in the transmission period, in accordance with the decision. Another example method by a UE generally includes signaling a capability of the UE to simultaneously receive, during a reception period, on a downlink and a sidelink; and receiving on the downlink while also receiving on the sidelink, in accordance with the capability.

### BACKGROUND

### Field of the Disclosure

Aspects of the present disclosure relate to wireless communications, and more particularly, to techniques for enhanced sidelink communication.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

Sidelink communications are communications from one UE to another UE. As the demand for mobile broadband access continues to increase, there exists a need for further improvements in NR and LTE technology, including improvements to sidelink communications. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. After reading the section entitled “Detailed Description” one will understand how the features of this disclosure provide advantages that include improved device-to-device communications in a wireless network.

Certain aspects of this disclosure provide a method for wireless communications by a user equipment (UE). The method generally includes deciding, when a conflict occurs between a sidelink discovery message and at least one other transmission in a transmission period, whether to transmit the sidelink discovery message or the at least one other transmission based, at least in part, on a priority of the sidelink discovery message; and transmitting the sidelink discovery message or the at least one other transmission in the transmission period, in accordance with the decision.

Certain aspects of this disclosure provide a method for wireless communications by a network entity. The method generally includes configuring a UE with a priority for sidelink discovery messages; deciding, when a conflict occurs between a sidelink discovery message and at least one uplink transmission in a transmission period, whether the UE is to transmit the at least one uplink transmission, based at least in part on the priority for sidelink discovery messages; and monitoring for the at least one uplink transmission in the transmission period, when the decision is that the UE is to transmit the at least one uplink transmission.

Certain aspects of this disclosure provide a method for wireless communications by a UE. The method generally includes signaling a capability of the UE to simultaneously receive, during a reception period, on a downlink and a sidelink; and receiving on the downlink while also receiving on the sidelink, in accordance with the capability.

Certain aspects of this disclosure provide a method for wireless communications by a network entity. The method generally includes receiving signaling, from a UE, indicating a capability of the UE to simultaneously receive, during a reception period, on a downlink and a sidelink; and transmitting to the UE on the downlink during the reception period, in accordance with the capability.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIGS. 5A and 5B show diagrammatic representations of example vehicle to everything (V2X) systems in accordance with some aspects of the present disclosure.

FIG. 6 illustrates an example allocation of a resource pool for sidelink communications, in accordance with certain aspects of the present disclosure.

FIG. 7 is an example resource pool for sidelink communication.

FIG. 8 illustrates two modes of sidelink communication.

FIGS. 9A and 9B are call flow diagrams illustrating example device discovery models, in accordance with certain aspects of the present disclosure.

FIG. 10 illustrated example operations for wireless communications by a sidelink UE, in accordance with certain aspects of the present disclosure.

FIG. 11 illustrates example operations for wireless communications by a network entity, in accordance with certain aspects of the present disclosure.

FIG. 12 illustrated example operations for wireless communications by a sidelink UE, in accordance with certain aspects of the present disclosure.

FIG. 13 illustrates example operations for wireless communications by a network entity, in accordance with certain aspects of the present disclosure.

FIGS. 14-17 illustrate communications devices that may include various components configured to perform one or more of the operations illustrated in FIGS. 10-13, respectively, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques for improved sidelink discovery communication.

For example, a user equipment may determine whether to transmit a sidelink discovery message or another transmission(s) based on a priority of the sidelink discovery message when a conflict occurs between the sidelink discovery message and the other transmission(s) in a transmission period. As another example, a UE may signal a capability of the UE to simultaneously receive, during a reception period, on a downlink and a sidelink.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QOS) requirements. In addition, these services may co-exist in the same subframe.

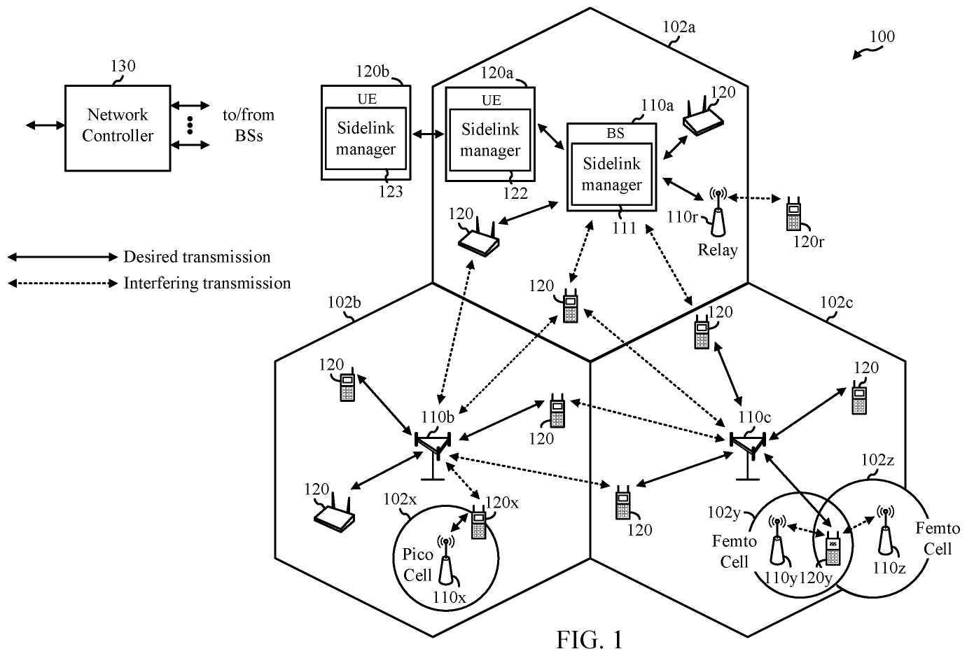

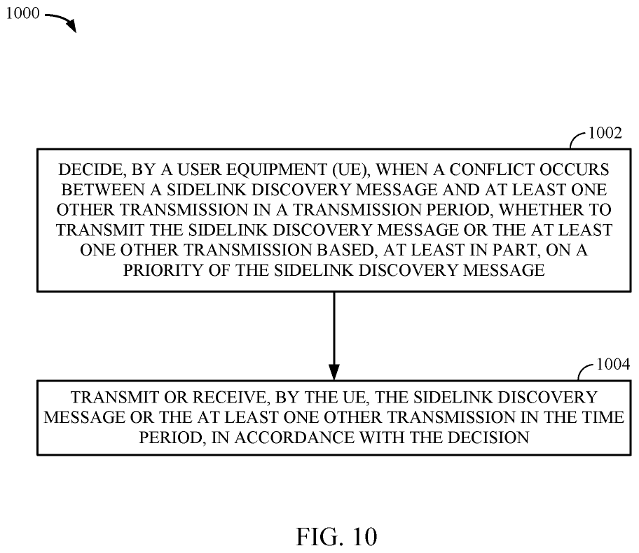

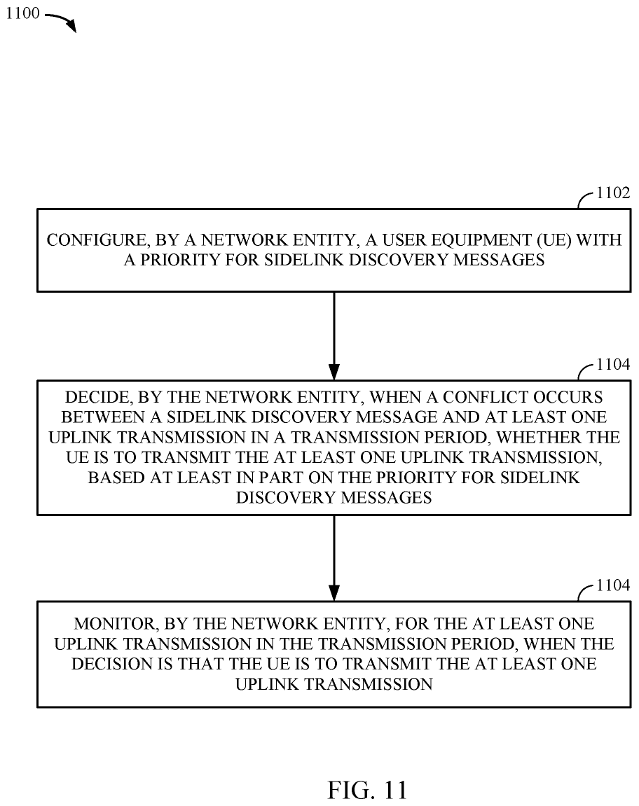

FIG. 1 illustrates an example wireless communication network 100 in which aspects of the present disclosure may be performed. For example, one or more UEs 120a and 120b of FIG. 1 may be configured to perform operations described below with reference to FIGS. 10 and/or 12 for improved sidelink discovery communication. Furthermore, a base station (BS) (e.g., a network entity) may be configured to perform operations described below with reference to FIGS. 11 and/or 13 for improved sidelink discovery communication.

As illustrated in FIG. 1, the wireless communication network 100 may include a number of base stations (BSs) 110a-z (each also individually referred to herein as BS 110 or collectively as BSs 110) and other network entities. In aspects of the present disclosure, a roadside service unit (RSU) may be considered a type of BS, and a BS 110 may be referred to as an RSU. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network.

In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

According to certain aspects, the UEs 120 may be configured for improved sidelink discovery communication. As shown in FIG. 1, the UE 120a includes a sidelink manager 122. The sidelink manager 122 may be configured to transmit/receive a sidelink communication to/from another UE, in accordance with aspects of the present disclosure. As shown in FIG. 1, the UE 120b includes a sidelink manager 123. The sidelink manager 123 may be configured to receive/transmit a sidelink communication from/to another UE, in accordance with aspects of the present disclosure.

According to certain aspects, the BS 110a may be configured to signal the UE 120a for configuring improved sidelink discovery communication. As shown in FIG. 1, the BS 110a includes a sidelink manager 111. The sidelink manager 111 may be configured to transmit/receive a wireless communication to/from the UE 120a (and/or the UE 120b), in accordance with aspects of the present disclosure.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IOT) devices, which may be narrowband IoT (NB-IOT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

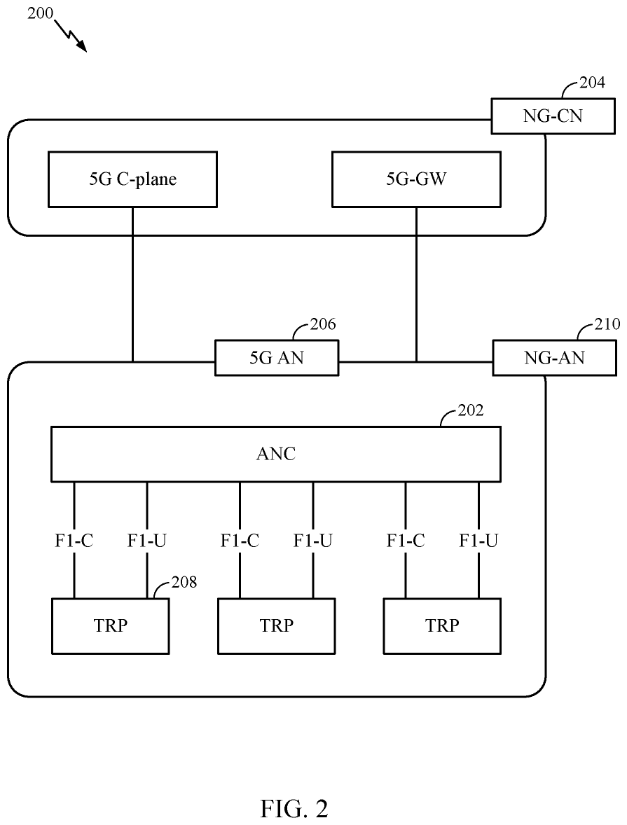

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

Logical functions may be dynamically distributed in the logical architecture of distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

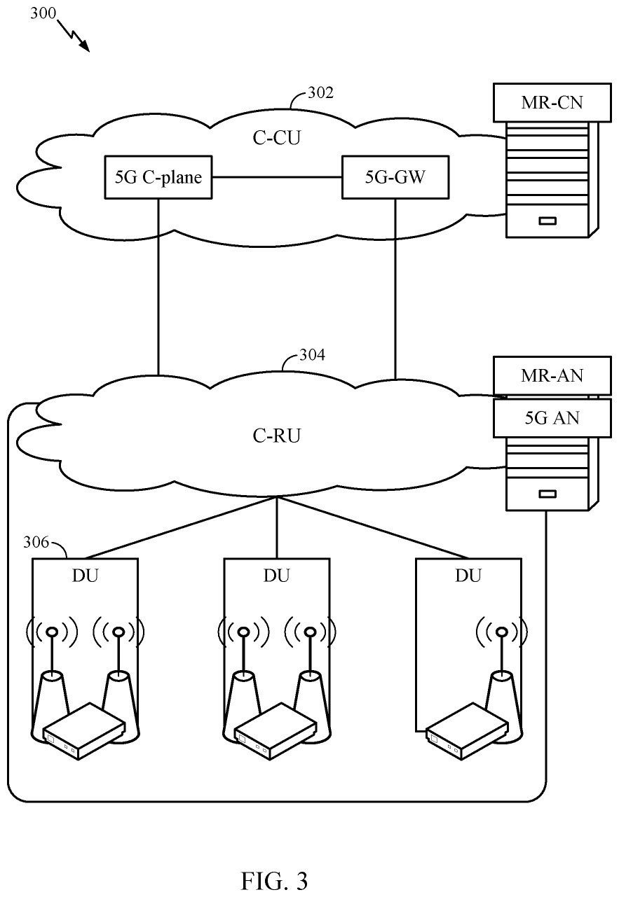

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

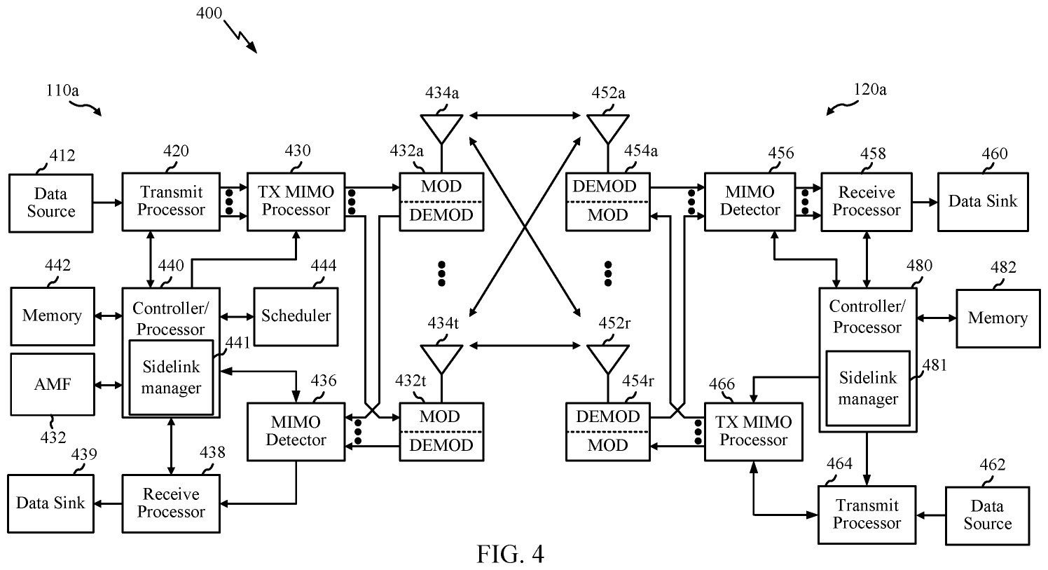

FIG. 4 illustrates example components of BS 110a and UE 120a (as depicted in FIG. 1), which may be used to implement aspects of the present disclosure. For example, antennas 452, processors 466, 458, 464, and/or controller/processor 480 of the UE 120a and/or UE 120b may be used to perform the various techniques and methods described herein with reference to FIGS. 10 and/or 12.

At the BS 110a, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120a, the antennas 452a through 452r may receive the downlink signals from the base station 110a and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120a to a data sink 460, and provide decoded control information to a controller/processor 480.

On the uplink, at UE 120a, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110a. At the BS 110a, the uplink signals from the UE 120a may be received by the antennas 434, processed by the modulators 432, detected by a MIMO detector 436 if applicable, and further processed by a receive processor 438 to obtain decoded data and control information sent by the UE 120a. The receive processor 438 may provide the decoded data to a data sink 439 and the decoded control information to the controller/processor 440.

The controllers/processors 440 and 480 may direct the operation at the BS 110a and the UE 120a, respectively. The processor 440 has a sidelink manager 441 that may be configured for configuring a UE, and/or other processors and modules at the BS 110a may perform or direct the execution of processes for the techniques described herein. As shown in FIG. 2, the controller/processor 480 of the UE 120a has a sidelink manager 481 that may be configured for transmitting a sidelink communication to another UE. Although shown at the controller/processor 480 and controller/processor 440, other components of the UE 120a and BS 110a may be used performing the operations described herein. The memories 442 and 482 may store data and program codes for BS 110a and UE 120a, respectively. A scheduler 444 may schedule UEs for data transmission on the downlink, sidelink, and/or uplink.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which typically use an unlicensed spectrum).

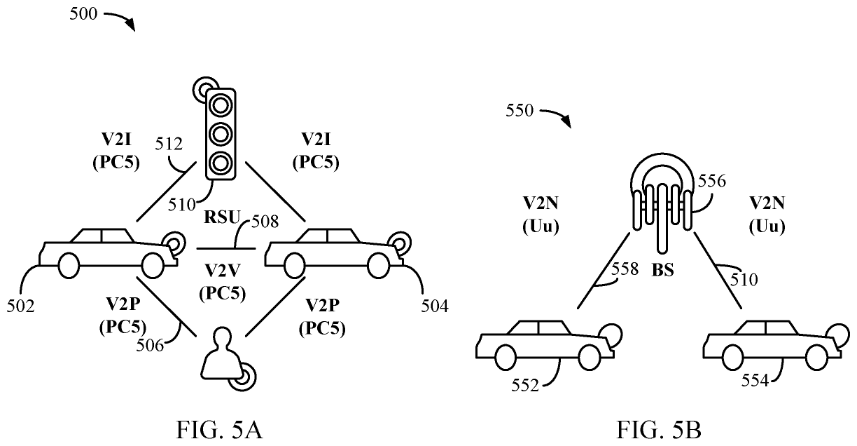

FIGS. 5A and 5B show diagrammatic representations of example vehicle to everything (V2X) systems in accordance with some aspects of the present disclosure. For example, the vehicles shown in FIGS. 5A and 5B may communicate via sidelink channels and may perform sidelink CSI reporting as described herein.

The V2X systems, provided in FIGS. 5A and 5B provide two complementary transmission modes. A first transmission mode, shown by way of example in FIG. 5A, involves direct communications (for example, also referred to as side link communications) between participants in proximity to one another in a local area. A second transmission mode, shown by way of example in FIG. 5B, involves network communications through a network, which may be implemented over a Uu interface (for example, a wireless communication interface between a radio access network (RAN) and a UE).

Referring to FIG. 5A, a V2X system 500 (for example, including vehicle-to-vehicle (V2V) communications) is illustrated with two vehicles 502, 504. The first transmission mode allows for direct communication between different participants in a given geographic location. As illustrated, a vehicle can have a wireless communication link 506 with an individual (i.e., vehicle to person (V2P), for example, via a UE) through a PC5 interface. Communications between the vehicles 502 and 504 may also occur through a PC5 interface 508. In a like manner, communication may occur from a vehicle 502 to other highway components (for example, roadside service unit 510), such as a traffic signal or sign (i.e., vehicle to infrastructure (V2I)) through a PC5 interface 512. With respect to each communication link illustrated in FIG. 5A, two-way communication may take place between elements, therefore each element may be a transmitter and a receiver of information. The V2X system 500 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 5B shows a V2X system 550 for communication between a vehicle 552 and a vehicle 554 through a network entity 556. These network communications may occur through discrete nodes, such as a base station (for example, an eNB or gNB), that sends and receives information to and from (for example, relays information between) vehicles 552, 554. The network communications through vehicle to network (V2N) links 558 and 510 may be used, for example, for long-range communications between vehicles, such as for communicating the presence of a car accident a distance ahead along a road or highway. Other types of communications may be sent by the node to vehicles, such as traffic flow conditions, road hazard warnings, environmental/weather reports, and service station availability, among other examples. Such data can be obtained from cloud-based sharing services.

In some circumstances, two or more subordinate entities (for example, UEs) may communicate with each other using sidelink signals. As described above, V2V and V2X communications are examples of communications that may be transmitted via a sidelink. When a UE is transmitting a sidelink communication on a sub-channel of a frequency band, the UE is typically unable to receive another communication (e.g., another sidelink communication from another UE) in the frequency band. Other applications of sidelink communications may include public safety or service announcement communications, communications for proximity services, communications for UE-to-network relaying, device-to-device (D2D) communications, Internet of Everything (IoE) communications, Internet of Things (IOT) communications, mission-critical mesh communications, among other suitable applications. Generally, a sidelink may refer to a direct link between one subordinate entity (for example, UE1) and another subordinate entity (for example, UE2). As such, a sidelink may be used to transmit and receive a communication (also referred to herein as a “sidelink signal”) without relaying the communication through a scheduling entity (for example, a BS), even though the scheduling entity may be utilized for scheduling or control purposes. In some examples, a sidelink signal may be communicated using a licensed spectrum (unlike wireless local area networks, which typically use an unlicensed spectrum).

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions.

For the operation regarding PSSCH, a UE performs either transmission or reception in a slot on a carrier. A reservation or allocation of transmission resources for a sidelink transmission is typically made on a sub-channel of a frequency band for a period of a slot. NR sidelink supports for a UE a case where all the symbols in a slot are available for sidelink, as well as another case where only a subset of consecutive symbols in a slot is available for sidelink.

PSFCH may carry feedback such as channel state information (CSI) related to a sidelink channel quality. A sequence-based PSFCH format with one symbol (not including AGC training period) may be supported. The following formats may be possible: a PSFCH format based on PUCCH format 2 and a PSFCH format spanning all available symbols for sidelink in a slot.

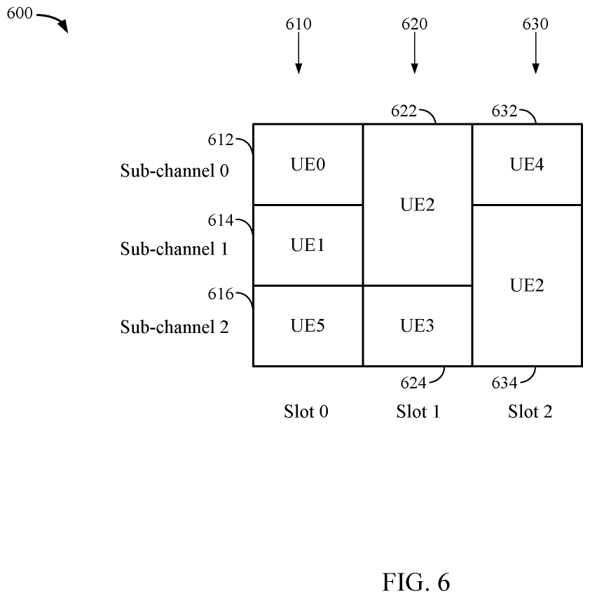

FIG. 6 is an example of how resources of a common resource pool 600 may be allocated for sidelink communications (broadcast and groupcast device-to-device or D2D) between UEs (e.g., UEs 110, shown in FIG. 1). As noted above, with reference to FIGS. 5A and 5B, sidelink generally refers to the link between two users, or user-relays can be used in different scenarios and for different applications. As previously described, when a UE is transmitting a sidelink communication on a sub-channel of a frequency band, the UE is typically unable to receive another communication (e.g., another sidelink communication from another UE) in the frequency band. Thus, sidelink communications may be referred to as being half-duplex. Thus, UEs 0, 1, and 5, which transmit sidelink communications 612, 614, and 616 respectively, cannot receive the sidelink communications from each other. That is, UE 0 cannot receive the sidelink transmissions 614 and 616. Similarly, UE 2 cannot receive the sidelink transmissions 624 and 632 from UEs 3 and 4, respectively. Also, UE 3 cannot receive sidelink transmission 622 from UE 2, and UE 4 cannot receive the sidelink transmission 634 from UE 2. In aspects of the present disclosure, a sidelink transmission(s) that cannot be received may be referred to as being “erased” for the UE or wireless node that cannot receive the sidelink transmission, because the UE has no information regarding that sidelink transmission. This is unlike other situations in which a UE fails to decode a transmission, because in those situations, the UE may retain some information regarding the transmission that the UE failed to decode, and the UE may combine that retained information with a retransmission that the UE receives to determine the transmission that the UE failed to decode.

According to previously known techniques, resource allocation is reservation based in NR sidelink communications. In these techniques, resource allocations are made in units of sub-channels in the frequency domain and are limited to one slot in the time domain. In the previously known techniques, a transmission may reserve resources in the current slot and in up to two future slots. Reservation information may be carried in sidelink control information (SCI). In the previously known techniques, sidelink control information (SCI) may be transmitted in two stages. A first stage SCI (SCI-1) may be transmitted on a physical sidelink control channel (PSCCH) and contains resource reservation information as well as information needed to decode a second stage SCI (SCI-2). A SCI-2 may be transmitted on the physical sidelink shared channel (PSSCH) and contains information needed to decode data on the shared channel (SCH) and to provide feedback (e.g., acknowledgments (ACKs) or negative acknowledgments (NAKs)) over the physical sidelink feedback channel (PSFCH).

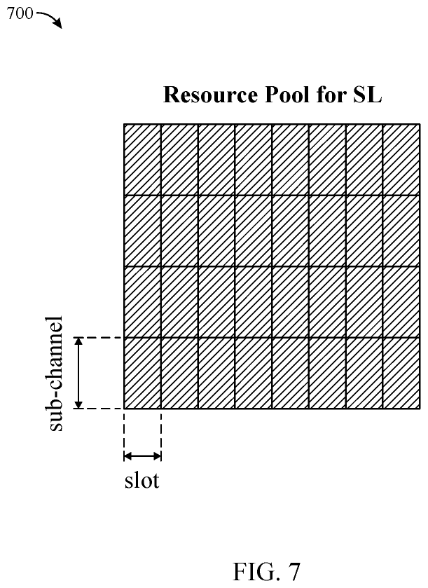

FIG. 7 is an example resource pool 700 for sidelink communication. As illustrated, the minimum resource allocation unit is a sub-channel in the frequency domain (i.e., as shown in the y axis) and the resource allocation in the time domain is a slot (i.e., as shown in the x axis). For example, depending on subcarrier spacing (SCS) values, and depending on whether a normal cyclic prefix (CP) or an extended CP is used, a slot in the time domain may include 12 or 14 orthogonal frequency division multiplexing (OFDM) symbols.

In the frequency domain, each subchannel may include a set number of consecutive resource blocks (RBs), which may include 12 consecutive subcarriers with the same SCS, such as 10, 15, 20, 25 . . . etc. consecutive RBs depending on practical configuration. Hereinafter, each unit of resource in one slot and in one subchannel is referred to as a resource, or resource unit. For a certain resource pool, the resources therein may be referred to using the coordinates of the slot index (e.g., the nth slot in the x axis of the time domain) and the subchannel index (e.g., the mth subchannel in the y axis of the frequency domain). Interchangeably, the slot index may be referred to as the time index; and the subchannel index may be referred to as the frequency index.

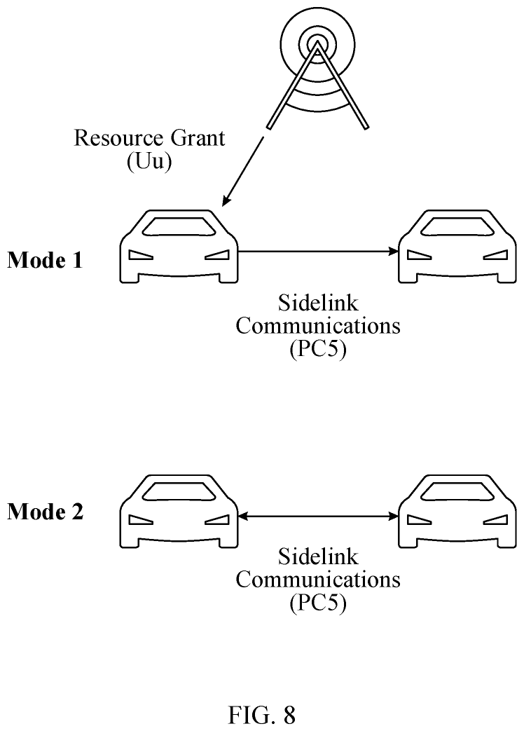

FIG. 8 illustrates two modes of resource allocation for sidelink communications, Mode 1 and Mode 2. Mode 1 and Mode 2 are briefly mentioned in FIGS. 5A and 5B and are further discussed with respect to FIG. 8.

In Mode 1 sidelink communication, the sidelink resources are often scheduled by a gNB. In Mode 2 sidelink communication, the UE may autonomously select sidelink resources from a (pre)configured sidelink resource pool(s) based on the channel sensing mechanism. When the UE is in-coverage, a gNB may be configured to adopt Mode 1 or Mode 2. When the UE is out of coverage, only Mode 2 may be adopted.

In Mode 2, when traffic arrives at a transmitting UE, the transmitting UE may select resources for PSCCH and PSSCH, and/or reserve resources for retransmissions to minimize latency. Therefore, in conventional configurations the transmitting UE would select resources for PSSCH associated with PSCCH for initial transmission and blind retransmissions, which incurs unnecessary resources and the related power consumption. To avoid such resource waste and other similar resource duplication/blind reservation/redundancy, the UEs in sidelink communication may communicate to use a subset of the resources.

### Example Reliability Enhancement for Sidelink Discovery

Aspects of the present disclosure relate to wireless communications, and more particularly, to techniques for improved sidelink discovery communication. For example, a user equipment (UE) may determine whether to transmit a sidelink discovery message or another transmission(s) based on a priority of the sidelink discovery message when a conflict occurs between the sidelink discovery message and the other transmission(s) in a transmission period. As another example, a UE may signal a capability of the UE to simultaneously receive, during a reception period, on a downlink and a sidelink. Thus, by using the priority of sidelink discovery messages and/or indicating a UE capability, sidelink communications for discovery purposes can be improved.

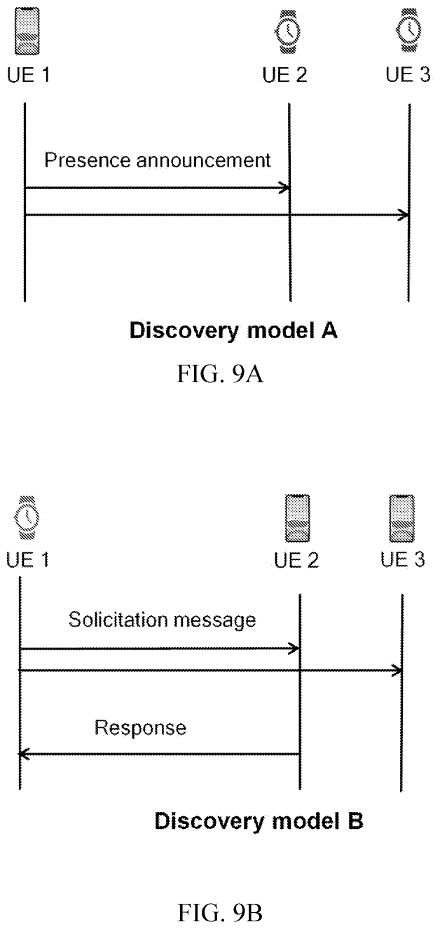

FIGS. 9A and 9B are call flow diagrams illustrating example device discovery models, in accordance with certain aspects of the present disclosure.

According to a first model (e.g., Discovery Model A) shown in FIG. 9A, a UE (e.g., UE 1) sends (e.g., periodically) a presence announcement. One or more UEs (e.g., UE 2 and UE 3) may be monitoring for such announcement to indicate the presence of UE 1. In this case, if any of UE 2 or UE 3 wish to communicate with UE 1, they may respond to the presence announcement (e.g., to connect to the UE 1 and/or utilize the UE 1 as a relay). In this case, UE 1 may be a mobile communications device such as a smart phone, and UEs 2 and 3 may be smart devices such as smart watches.

For a second model (e.g., Discovery Model B) shown in FIG. 9B, UE 1 (a discoverer) may send a solicitation message to UE 2 and/or UE 3 (or additional UEs) to discover other UEs (e.g., UE 2 and UE 3) (discoverees). In this case, UE 1 may be a smart device such as a smart watch, and UEs 2 and 3 may be mobile communications devices such as smart phones. In the case shown, the solicitation messages may be sent on a PC5 communication channel (e.g., and not on separate discovery channel). Discovery messages may be carried within the same layer-2 frames as those used for other direct communication including, for example, the Destination Layer-2 identifier (ID) that can be set to a unicast, groupcast or broadcast identifier, the Source Layer-2 ID that is always set to a unicast identifier of the transmitter, and the frame type indicates that it is a ProSe Direct Discovery message.

In long term evolution (LTE) communications, to enhance intra-frequency and/or inter-frequency sidelink discovery performance for a non-dedicated transceiver case, a network entity (e.g., an eNB) may provide gaps to a UE.

These gaps may be configured so that a radio frequency (RF) transmitter/receiver chain can be reused for sidelink discovery transmissions/receptions. In this regard, the gaps provided for sidelink discovery transmission/reception may take into account any additional overhead (e.g., for synchronization, subframe offset between serving carrier and sidelink discovery carrier, and/or interruption time for retuning). Moreover, the eNB can de-configure a configured sidelink discovery transmission and/or reception gaps. With the configuration of the discovery gaps, such a configuration may be applicable for all configured cells of a given UE.

In some cases, if SIB19 is not broadcast by the serving cell, the UE may not enter a radio resource control (RRC) connected state (RRC_CONNECTED) with the serving cell to request gaps or resources for sidelink discovery announcement. In some cases, the eNB may indicate (e.g., via broadcast or dedicated signalling) whether the UE can request gaps.

According to some implementations, a UE can trigger a gap request for sidelink discovery announcement or monitoring. In the gap request, the UE may inform the eNB of the subframes (with respect to the timing of serving cell) during which the UE may desire gaps. It should be noted that the UE may not be expected to monitor any physical downlink channels during sidelink discovery reception gaps.

During a transmission gap, the UE may prioritize discovery announcement(s) over cellular (Uu) uplink transmission and/or sidelink communication transmission. This may occur when a conflict with sidelink discovery announcement occurs. Additionally, the UE may prioritize a random access channel (RACH) procedure over the sidelink gaps.

It should be noted that measurement requirements on a serving frequency may not be affected by the sidelink gaps. If the network does not configure transmission and reception gaps for sidelink discovery, intra-frequency and/or inter-frequency discovery of the same and another public land mobile network (PLMN) sidelink discovery announcement may not affect Uu transmission(s).

Moreover, intra-frequency, inter-frequency, and inter-PLMN sidelink discovery monitoring may not affect Uu reception. In some cases, the UE may not create autonomous gaps for announcement or monitoring of sidelink discovery. The UE may use discontinuous reception (DRX) occasions in an RRC_IDLE mode and/or a RRC_CONNECTED mode, or use a second reception chain if one is available, for intra-frequency, inter-frequency, and/or inter-PLMN discovery message monitoring. In some cases, an RRC_CONNECTED UE may send a sidelink UE information message to the serving cell if it is interested (or no longer interested) in intra-frequency, inter-frequency, or inter-PLMN discovery message monitoring.

In LTE, when a UE is configured with discovery reception gap, the UE may not be required to monitor Uu communications. However, a drawback of this approach is that if a UE has high priority services (e.g., ultra-reliable low latency communications (URLLC)), the UE may not be able to be served during the discovery gaps.

In other words, configuring a UE with discovery gaps without any consideration for high priority Uu communication is not desirable. This is because during the discovery “transmission” gap, a discovery signal may be prioritized over uplink (UL) transmissions, even those of high priority. The prioritization of a discovery signal (over other uplink signals) is generally provided by current NR enhancements.

Thus, certain aspects of the present disclosure provide techniques for protecting the high priority UL transmissions (e.g., URLLC transmissions), by comparing the respective priorities of various transmissions instead of applying a fixed rule. Moreover, in some cases, a UE may signal a capability of the UE to simultaneously receive, during a reception period, on downlink and sidelink.

FIG. 10 illustrates example operations 1000 for wireless communications by a UE, in accordance with certain aspects of the present disclosure. For example, operations 1000 may be performed by a UE 120a of FIG. 1 or FIG. 4 (e.g., when performing sidelink communications with another UE).

Operations 1000 begin, at 1002, by deciding, when a conflict occurs between a sidelink discovery message and at least one other transmission in a transmission period, whether to transmit the sidelink discovery message or the at least one other transmission based, at least in part, on a priority of the sidelink discovery message. At 1004, the UE transmits or receives the sidelink discovery message or the at least one other transmission in the transmission period, in accordance with the decision.

FIG. 11 illustrates example operations 1100 for wireless communications by a network entity that may be considered complementary to operations 1000 of FIG. 10. For example, operations 1100 may be performed by a BS 110a of FIG. 1 to configure a UE (e.g., a UE performing the operations 1000 of FIG. 10) for improved sidelink discovery communications.

Operations 1100 begin, at 1102, by configuring a UE with a priority for sidelink discovery messages. At 1104, the network entity decides, when a conflict occurs between a sidelink discovery message and at least one uplink transmission in a transmission period, whether the UE is to transmit the at least one uplink transmission, based at least in part on the priority for sidelink discovery messages. At 1106, the network entity monitors for the at least one uplink transmission in the transmission period, when the decision is that the UE is to transmit the at least one uplink transmission.

In certain aspects, prioritization may be made across discovery signals, where Uu UL transmission and other SL transmissions can be performed by taking the discovery signal priority into account. This can be the case when a separate resource pool is configured for discovery (or not configured). If a separate pool for discovery is configured, the prioritization may be used during the discovery transmission gaps configured for a UE. If a resource pool is shared for discovery and SL communication, or if gaps are not configured, the prioritization can still be done by taking the priority of discovery, other SL transmissions, and UL transmissions into account.

A discussed above, in LTE, a UE is not required to receive on Uu during the configured discovery reception gaps. Thus, in certain aspects, a UE capability for simultaneous reception on Uu and sidelink may be defined.

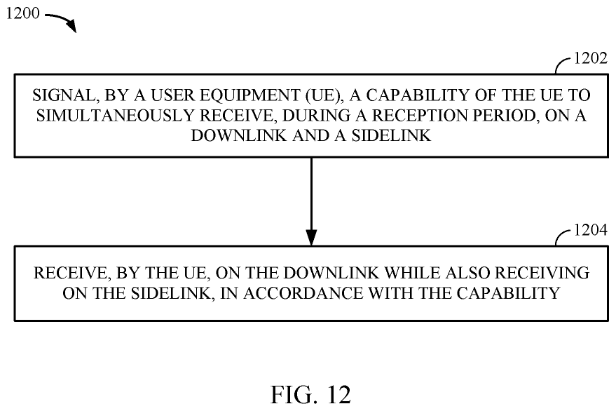

FIG. 12 illustrates example operations 1200 for wireless communications by a UE, in accordance with certain aspects of the present disclosure. For example, operations 1200 may be performed by a UE 120a of FIG. 1 or FIG. 4 (e.g., when performing sidelink communications with another UE).

Operations 1200 begin, at 1202, by signaling a capability of the UE to simultaneously receive, during a reception period, on a downlink and a sidelink. At 1204, the UE receives on the downlink while also receiving on the sidelink, in accordance with the capability.

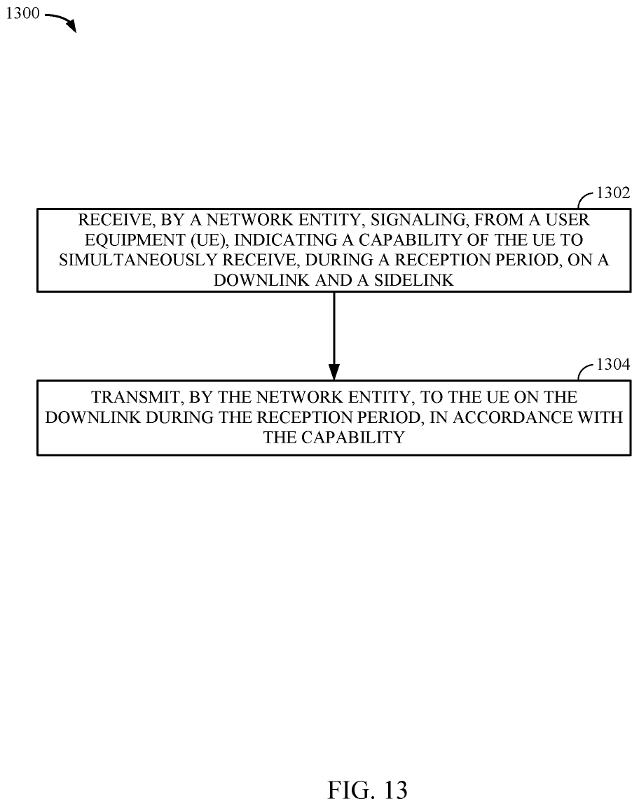

FIG. 13 illustrates example operations 1300 for wireless communications by a network entity that may be considered complementary to operations 1200 of FIG. 12. For example, operations 1300 may be performed by a BS 110a of FIG. 1 to communicate with a UE (e.g., a UE performing the operations 1200 of FIG. 12) for improved sidelink discovery communications.

Operations 1300 begin, at 1302, by receiving signaling, from a UE, indicating a capability of the UE to simultaneously receive, during a reception period, on a downlink and a sidelink. At 1304, the network entity transmits to the UE on the downlink during the reception period, in accordance with the capability.

In some cases, the capability may be a function of different conditions such as received signal power difference between Uu DL and sidelink reception and/or subcarrier spacing (SCS) used for DL compared to sidelink, aligned physical resource block (PRB) grid, and/or bandwidth part (BWP) configuration for DL and sidelink (e.g., one BWP is fully inside the other one). In some aspects, for monitoring a physical downlink control channel (PDCCH) during a discovery reception gap, additional relaxation can be introduced. That is, based on a UE capability, a UE may be able to decode a reduced (e.g., “lite”) PDCCH which involves a smaller number of blind decoding (BD) attempts and/or control channel elements (CCEs) per slot/span, at least as compared to the regular PDCCH.

In addition, a downlink control information (DCI) size budget per slot and/or number of DCIs with pending physical downlink shared channels (PDSCHs) and/or physical uplink shared channels (PUSCHs) can be relaxed/reduced (e.g., the number of DL DCIs received for which the UE has not received any corresponding PDSCH or has not transmitted any corresponding PUSCH may be reduced). In certain aspects, some search spaces (e.g., PDCCH search spaces or PDCCH CORESETs) may be assumed as inactive during the gap and not monitored by a UE (e.g., which may be indicated via RRC signaling). In some cases, a PDCCH in some carriers may be assumed to be deactivated completely, and a UE may only monitor PDCCH on a subset of carriers.

If a UE is capable of receiving DL transmissions during the discovery reception gaps, various scenarios may occur. For example, a UE may detect a DL grant to receive a PDSCH during the gap and/or the UE may detect an UL grant to transmit a PUSCH during the gap.

In certain aspects, during discovery reception gaps, the prioritization between PUSCH and discovery reception may be accomplished by comparing the priority of a discovery signal and the PUSCH. This may also hold true for prioritization between a configured grant (CG) PUSCH transmission and discovery signal reception.

In certain aspects, during the discovery reception gaps, a UE may receive both a discovery signal(s) and PDSCH. The PDSCH scheduling may have some restrictions on parameters such as the number of resource blocks (RBs), the number of layers, transport block size (TBS), modulation and coding scheme (MCS), and/or the number of carriers on which PDSCH can be scheduled or received. A maximum allowed setting for these parameters could be based on the UE capability.

In certain aspects, if the UE is configured with semi-persistent scheduling (SPS) configurations, and if a SPS configuration does not follow a parameter setting as described above, the SPS occasions may be skipped by the UE. In some cases, if an SPS occasion of an SPS configuration is skipped during the discovery gap, the UE may not report acknowledgement (ACK) information (e.g., hybrid automatic repeat request (HARQ) ACK).

In some cases, in the case of a tie when comparing discovery, other SL transmissions, and UL transmission priorities, a UE may (always) send discovery during the discovery gap or (always) send other sidelink channels or UL. In some cases, one or more rules used to implement the above mentioned comparison may be RRC configured. It should be noted that the rules could be the same (or different) during the discovery gaps and outside of the discovery gaps (or even when a UE is not configured with the gaps.)

### Example Communications Devices

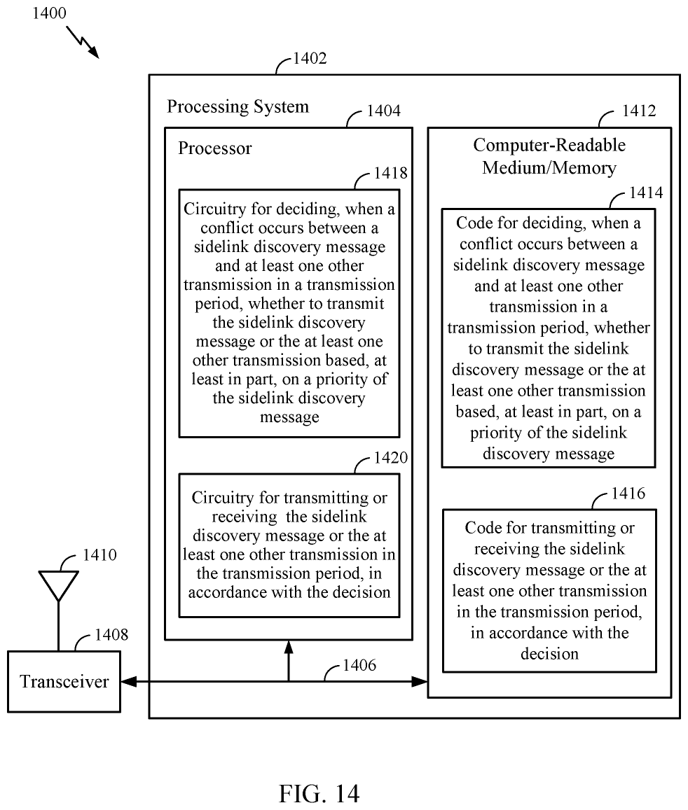

FIG. 14 illustrates a communications device 1400 that may include various components (e.g., corresponding to means-plus-function components) configured to perform operations for the techniques disclosed herein, such as the operations 1000 illustrated in FIG. 10. The communications device 1400 includes a processing system 1402 coupled to a transceiver 1408. The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations 1000 illustrated in FIG. 10, and/or other operations described herein. In certain aspects, computer-readable medium/memory 1412 stores code 1414 for deciding, when a conflict occurs between a sidelink discovery message and at least one other transmission in a transmission period, whether to transmit the sidelink discovery message or the at least one other transmission based, at least in part, on a priority of the sidelink discovery message; and code 1416 for transmitting or receiving the sidelink discovery message or the at least one other transmission in the transmission period, in accordance with the decision.

In certain aspects, the processor 1404 has circuitry configured to implement the code stored in the computer-readable medium/memory 1412. The processor 1404 includes circuitry 1418 for deciding, when a conflict occurs between a sidelink discovery message and at least one other transmission in a transmission period, whether to transmit the sidelink discovery message or the at least one other transmission based, at least in part, on a priority of the sidelink discovery message; and circuitry 1420 for transmitting or receiving the sidelink discovery message or the at least one other transmission in the transmission period, in accordance with the decision.

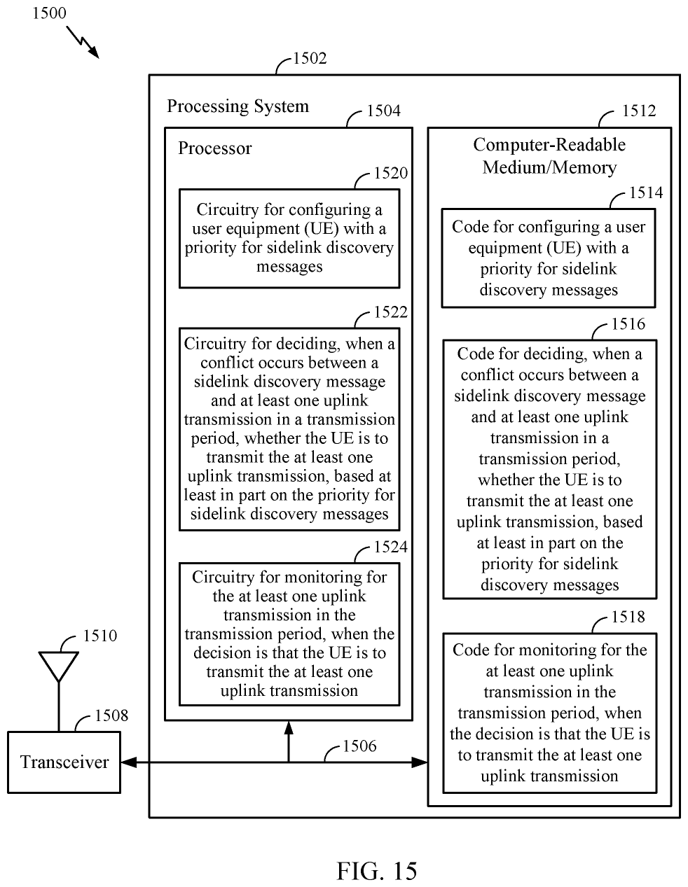

FIG. 15 illustrates a communications device 1500 that may include various components (e.g., corresponding to means-plus-function components) configured to perform operations for the techniques disclosed herein, such as the operations 1100 illustrated in FIG. 11. The communications device 1500 includes a processing system 1502 coupled to a transceiver 1508. The transceiver 1508 is configured to transmit and receive signals for the communications device 1500 via an antenna 1510, such as the various signals as described herein. The processing system 1502 may be configured to perform processing functions for the communications device 1500, including processing signals received and/or to be transmitted by the communications device 1500.

The processing system 1502 includes a processor 1504 coupled to a computer-readable medium/memory 1512 via a bus 1506. In certain aspects, the computer-readable medium/memory 1512 is configured to store instructions (e.g., computer-executable code) that when executed by the processor 1504, cause the processor 1504 to perform the operations 1100 illustrated in FIG. 11, and/or other operations described herein. In certain aspects, computer-readable medium/memory 1512 stores code 1514 for configuring a user equipment (UE) with a priority for sidelink discovery messages; code 1516 for deciding, when a conflict occurs between a sidelink discovery message and at least one uplink transmission in a transmission period, whether the UE is to transmit the at least one uplink transmission, based at least in part on the priority for sidelink discovery messages; and code 1518 for monitoring for the at least one uplink transmission in the transmission period, when the decision is that the UE is to transmit the at least one uplink transmission.

In certain aspects, the processor 1504 has circuitry configured to implement the code stored in the computer-readable medium/memory 1512. The processor 1504 includes circuitry 1520 for configuring a user equipment (UE) with a priority for sidelink discovery messages; circuitry 1522 for deciding, when a conflict occurs between a sidelink discovery message and at least one uplink transmission in a transmission period, whether the UE is to transmit the at least one uplink transmission, based at least in part on the priority for sidelink discovery messages; and circuitry 1524 for monitoring for the at least one uplink transmission in the transmission period, when the decision is that the UE is to transmit the at least one uplink transmission.

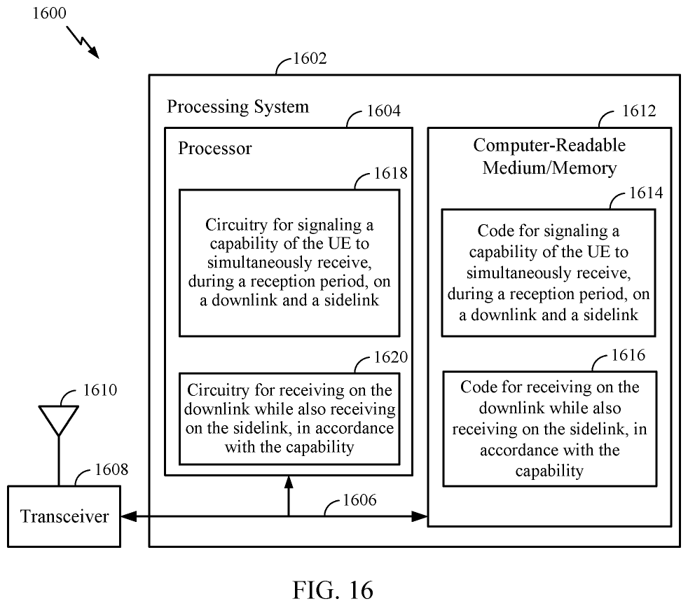

FIG. 16 illustrates a communications device 1600 that may include various components (e.g., corresponding to means-plus-function components) configured to perform operations for the techniques disclosed herein, such as the operations 1200 illustrated in FIG. 12. The communications device 1600 includes a processing system 1602 coupled to a transceiver 1608. The transceiver 1608 is configured to transmit and receive signals for the communications device 1600 via an antenna 1610, such as the various signals as described herein. The processing system 1602 may be configured to perform processing functions for the communications device 1600, including processing signals received and/or to be transmitted by the communications device 1600.

The processing system 1602 includes a processor 1604 coupled to a computer-readable medium/memory 1612 via a bus 1606. In certain aspects, the computer-readable medium/memory 1612 is configured to store instructions (e.g., computer-executable code) that when executed by the processor 1604, cause the processor 1604 to perform the operations 1200 illustrated in FIG. 12, and/or other operations described herein. In certain aspects, computer-readable medium/memory 1612 stores code 1614 for signaling a capability of the UE to simultaneously receive, during a reception period, on a downlink and a sidelink; and code 1616 for receiving on the downlink while also receiving on the sidelink, in accordance with the capability.

In certain aspects, the processor 1604 has circuitry configured to implement the code stored in the computer-readable medium/memory 1612. The processor 1604 includes circuitry 1618 for signaling a capability of the UE to simultaneously receive, during a reception period, on a downlink and a sidelink; and circuitry 1620 for receiving on the downlink while also receiving on the sidelink, in accordance with the capability.

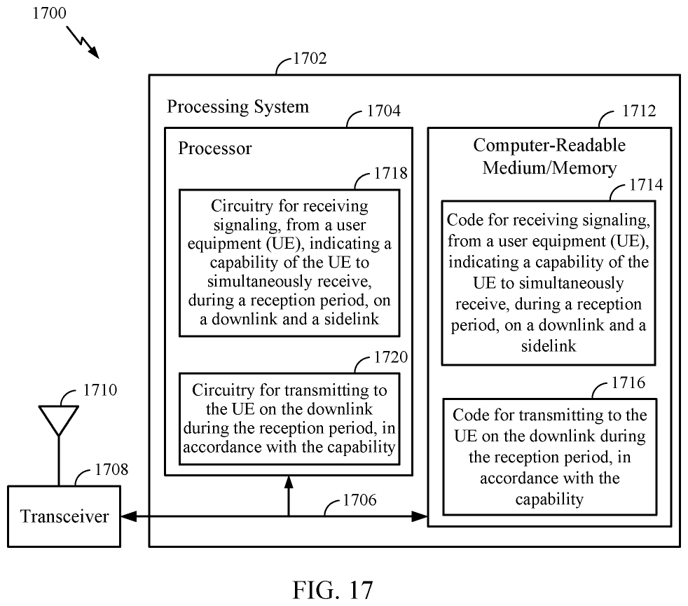

FIG. 17 illustrates a communications device 1700 that may include various components (e.g., corresponding to means-plus-function components) configured to perform operations for the techniques disclosed herein, such as the operations 1300 illustrated in FIG. 13. The communications device 1700 includes a processing system 1702 coupled to a transceiver 1708. The transceiver 1708 is configured to transmit and receive signals for the communications device 1700 via an antenna 1710, such as the various signals as described herein. The processing system 1702 may be configured to perform processing functions for the communications device 1700, including processing signals received and/or to be transmitted by the communications device 1700.

The processing system 1702 includes a processor 1704 coupled to a computer-readable medium/memory 1712 via a bus 1706. In certain aspects, the computer-readable medium/memory 1712 is configured to store instructions (e.g., computer-executable code) that when executed by the processor 1704, cause the processor 1704 to perform the operations 1300 illustrated in FIG. 13, and/or other operations described herein. In certain aspects, computer-readable medium/memory 1712 stores code 1714 for receiving signaling, from a user equipment (UE), indicating a capability of the UE to simultaneously receive, during a reception period, on a downlink and a sidelink; and code 1716 for transmitting to the UE on the downlink during the reception period, in accordance with the capability.

In certain aspects, the processor 1704 has circuitry configured to implement the code stored in the computer-readable medium/memory 1712. The processor 1704 includes circuitry 1718 for receiving signaling, from a user equipment (UE), indicating a capability of the UE to simultaneously receive, during a reception period, on a downlink and a sidelink; and circuitry 1720 for transmitting to the UE on the downlink during the reception period, in accordance with the capability.

### Example Aspects

Aspect 1. A method for wireless communications by a user equipment (UE), comprising deciding, when a conflict occurs between a sidelink discovery message and at least one other transmission in a transmission period, whether to process the sidelink discovery message or the at least one other transmission based, at least in part, on a priority of the sidelink discovery message; and transmitting or receiving the sidelink discovery message or the at least one other transmission in the transmission period, in accordance with the decision.

Aspect 2. The method of Aspect 1, wherein the at least one transmission comprises at least one of an uplink transmission to a network entity or a sidelink transmission to another UE.

Aspect 3. The method of Aspect 1 or 2, further comprising receiving signaling configuring the UE with transmission gaps for transmitting sidelink discovery messages, wherein the transmission period comprises one of the configured transmission gaps.

Aspect 4. The method of any of Aspects 1-3, wherein separate resource pools are configured for sidelink discovery messages and other sidelink communication.

Aspect 5. The method of any of Aspects 1-4, wherein a resource pool is shared for sidelink discovery messages and other sidelink communication.

Aspect 6. The method of any of Aspects 1-5, wherein the decision is made by comparing the priority of the sidelink discovery message to a priority of the at least one other transmission.

Aspect 7. The method of any of Aspects 6, wherein, in an event the priority of the sidelink discovery message and the priority of the at least one other transmission are the same, the decision is based on a rule.

Aspect 8. The method of Aspect 7, wherein the rule dictates that, the event the priority of the sidelink discovery message and the priority of the at least one other transmission are the same the UE always sends the discovery message; or the UE always sends the at least one other transmission.

Aspect 9. The method of Aspect 8, wherein, when the UE is configured with transmission gaps for transmitting sidelink discovery messages, the rule is applied within transmission gaps.

Aspect 10. The method of Aspect 8 or 9, wherein the rule is applied only when the UE is configured with transmission gaps.

Aspect 11. A method for wireless communications by a network entity, comprising configuring a UE with a priority for sidelink discovery messages; deciding, when a conflict occurs between a sidelink discovery message and at least one uplink transmission in a transmission period, whether the UE is to transmit the at least one uplink transmission, based at least in part on the priority for sidelink discovery messages; and monitoring for the at least one uplink transmission in the transmission period, when the decision is that the UE is to transmit the at least one uplink transmission.

Aspect 12. The method of Aspect 11, further comprising transmitting signaling configuring the UE with transmission gaps for transmitting sidelink discovery messages, wherein the transmission period comprises one of the configured transmission gaps.

Aspect 13. The method of Aspect 11 or 12, wherein separate resource pools are configured for sidelink discovery messages and other sidelink communication.

Aspect 14. The method of any of Aspects 11-13, wherein a resource pool is shared for sidelink discovery messages and other sidelink communication.

Aspect 15. The method of any of Aspects 11-14, wherein the decision is made by comparing the priority of the sidelink discovery message to a priority of the at least one uplink transmission.

Aspect 16. The method of Aspect 15, wherein, in an event the priority of the sidelink discovery message and the priority of the at least one uplink transmission are the same, the decision is based on a rule.

Aspect 17. The method of Aspect 16, wherein the rule dictates that, the event the priority of the sidelink discovery message and the priority of the at least one uplink transmission are the same the UE always sends the discovery message; or the UE always sends the at least one uplink transmission.

Aspect 18. The method of Aspect 17, wherein, when the UE is configured with transmission gaps for transmitting sidelink discovery messages, the rule is applied within transmission gaps.

Aspect 19. The method of Aspect 17 or 18, wherein the rule is applied only when the UE is configured with transmission gaps.

Aspect 20. A method for wireless communications by a UE, comprising signaling a capability of the UE to simultaneously receive, during a reception period, on a downlink and a sidelink; and receiving on the downlink while also receiving on the sidelink, in accordance with the capability.

Aspect 21. The method of Aspect 20, wherein the capability is a function of one or more conditions.

Aspect 22. The method of Aspect 21, wherein the one or more conditions relate to at least one of a received signal power difference between the downlink and the sidelink; or a difference in subcarrier spacing (SCS) between the downlink and the sidelink.

Aspect 23. The method of Aspect 21 or 22, wherein the one or more conditions relate to at least one of an aligned physical resource block (PRB) grid; a bandwidth part (BWP) configuration for the downlink; or a bandwidth part (BWP) configuration for the sidelink.

Aspect 24. The method of any of Aspects 20-23, wherein the UE supports reduced capability reception on at least one of the downlink or sidelink, when simultaneously receiving on the downlink or sidelink.

Aspect 25. The method of Aspect 24, wherein the reduced capability reception involves decoding physical downlink control channels (PDCCHs) with a smaller number of blind decodes (BDs) or control channel elements (CCEs) within an occasion as compared to regular PDCCHs.

Aspect 26. The method of Aspect 24 or 25, wherein the reduced capability reception involves the UE supporting at least one of a reduced downlink control information (DCI) size budget per slot; or a reduced number of DCIs with pending physical downlink shared channels (PDSCHs) or physical uplink shared channel (PUSCH).

Aspect 27. The method of any of Aspects 24-26, wherein the reduced capability reception involves the UE monitoring for physical downlink control channels (PDCCHs) on a reduced number of search spaces or control resource sets (CORESETs).

Aspect 28. The method of any of Aspects 24-27, further comprising receiving signaling configuring the UE with discovery reception gaps for monitoring for sidelink discovery messages from other UEs, wherein the reception period comprises one of the configured discovery reception gaps.

Aspect 29. The method of Aspect 28, wherein, during the discovery reception gaps, the UE applies a prioritization between physical uplink shared channel (PUSCH) transmission and discovery reception by comparing a priority of discovery messages to a priority of a PUSCH.

Aspect 30. The method of Aspect 28 or 29, wherein, during the discovery reception gaps, the UE receives both a discovery message and a physical downlink shared channel (PDSCH).

Aspect 31. The method of Aspect 30, wherein the reduced capability reception involves monitoring for PDSCH transmissions based on restrictions on at least one of: a number of resource blocks, a number of layers, a transport block size (TBS), a modulating and coding scheme (MCS), or scheduling PSDCH on a reduced number of carriers.

Aspect 32. The method of any of Aspects 27-31, wherein the UE is configured with at least one semi persistent scheduling (SPS) configuration; and one or more SPS occasions are skipped during discovery gaps.

Aspect 33. The method of Aspect 32, wherein, the UE refrains from sending acknowledgment feedback when one or more SPS occasions are skipped.

Aspect 34. A method for wireless communications by a network entity, comprising receiving signaling, from a UE, indicating a capability of the UE to simultaneously receive, during a reception period, on a downlink and a sidelink; and transmitting to the UE on the downlink during the reception period, in accordance with the capability.

Aspect 35. The method of Aspect 34, wherein the capability is a function of one or more conditions.

Aspect 36. The method of Aspect 35, wherein the one or more conditions relate to at least one of a received signal power difference between the downlink and the sidelink; or a difference in subcarrier spacing (SCS) between the downlink and the sidelink.

Aspect 37. The method of Aspect 35 or 36, wherein the one or more conditions relate to at least one of an aligned physical resource block (PRB) grid; a bandwidth part (BWP) configuration for the downlink; or a bandwidth part (BWP) configuration for the sidelink.

Aspect 38. The method of any of Aspects 34-37, wherein the UE supports reduced capability reception on at least one of the downlink or sidelink, when simultaneously receiving on the downlink or sidelink.

Aspect 39. The method of Aspect 38, wherein the reduced capability reception involves decoding physical downlink control channels (PDCCHs) with a smaller number of blind decodes (BDs) or control channel elements (CCEs) within an occasion as compared to regular PDCCHs.

Aspect 40. The method of Aspect 38 or 39, wherein the reduced capability reception involves the UE supporting at least one of a reduced downlink control information (DCI) size budget per slot; or a reduced number of DCIs with pending physical downlink shared channels (PDSCHs) or physical uplink shared channel (PUSCH).

Aspect 41. The method of any of Aspects 38-40, wherein the reduced capability reception involves the UE monitoring for physical downlink control channels (PDCCHs) on a reduced number of search spaces.

Aspect 42. The method of any of Aspects 38-41, further comprising transmitting signaling configuring the UE with discovery reception gaps for monitoring for sidelink discovery messages from other UEs, wherein the reception period comprises one of the configured discovery reception gaps.

Aspect 43. The method of Aspect 42, wherein, during the discovery reception gaps, the UE applies a prioritization between physical uplink shared channel (PUSCH) transmission and discovery reception by comparing a priority of discovery messages to a priority of a PUSCH.

Aspect 44. The method of Aspect 42 or 43, wherein, during the discovery reception gaps, the UE is configured to receive both a discovery message and a physical downlink shared channel (PDSCH).

Aspect 45. The method of Aspect 44, wherein the reduced capability reception involves monitoring for PDSCH transmissions based on restrictions on at least one of: a number of resource blocks, a number of layers, a transport block size (TBS), or a modulating and coding scheme (MCS).

Aspect 46. The method of any of Aspects 41-45, wherein the UE is configured with at least one semi persistent scheduling (SPS) configuration; and the UE is configured to skip one or more SPS occasions during discovery gaps.

Aspect 47. The method of Aspect 46, wherein, the network entity refrains from monitoring for acknowledgment feedback when one or more SPS occasions are skipped.

Aspect 48: An apparatus, comprising: a memory comprising executable instructions; and one or more processors configured to execute the executable instructions and cause the apparatus to perform a method in accordance with any one of Aspects 1-47.

Aspect 49: An apparatus, comprising means for performing a method in accordance with any one of Aspects 1-47.

Aspect 50: A non-transitory computer-readable medium comprising executable instructions that, when executed by one or more processors of an apparatus, cause the apparatus to perform a method in accordance with any one of Aspects 1-47.

Aspect 51: A computer program product embodied on a computer-readable storage medium comprising code for performing a method in accordance with any one of Aspects 1-47.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIGS. 10-13 may be performed by various processors shown in FIG. 4, such as processors 466, 458, 464, and/or controller/processor 480 of the UE 120a (and/or UE 120b of FIG. 1).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations 1000 described herein and illustrated in FIGS. 10-13.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications at a user equipment (UE), comprising:
at least one memory comprising computer-executable instructions; and
one or more processors configured to execute the computer-executable instructions and cause the UE to:
decide, when a conflict occurs between a sidelink discovery message and at least one other transmission in a transmission period, whether to process the sidelink discovery message or the at least one other transmission based, at least in part, on a priority of the sidelink discovery message; and
transmit or receive the sidelink discovery message or the at least one other transmission in the transmission period, in accordance with the decision.

2. The apparatus of claim 1, wherein the at least one transmission comprises at least one of an uplink transmission to a network entity or a sidelink transmission to another UE.

3. The apparatus of claim 1, wherein the one or more processors are further configured to execute the computer-executable instructions and cause the UE to receive signaling configuring the UE with transmission gaps for transmitting sidelink discovery messages, wherein the transmission period comprises one of the configured transmission gaps.

4. The apparatus of claim 1, wherein separate resource pools are configured for sidelink discovery messages and other sidelink communication.

5. The apparatus of claim 1, wherein a resource pool is shared for sidelink discovery messages and other sidelink communication.

6. The apparatus of claim 1, wherein the decision is made by comparing the priority of the sidelink discovery message to a priority of the at least one other transmission.

7. The apparatus of claim 6, wherein, in an event the priority of the sidelink discovery message and the priority of the at least one other transmission are the same, the decision is based on a rule.

8. The apparatus of claim 7, wherein the rule dictates that, the event the priority of the sidelink discovery message and the priority of the at least one other transmission are the same:
the UE always sends the discovery message; or
the UE always sends the at least one other transmission.

9. The apparatus of claim 8, wherein, when the UE is configured with transmission gaps for transmitting sidelink discovery messages, the rule is applied within transmission gaps.

10. The apparatus of claim 8, wherein the rule is applied only when the UE is configured with transmission gaps.

11. An apparatus for wireless communications by a network entity, comprising:
at least one memory comprising computer-executable instructions; and
one or more processors configured to execute the computer-executable instructions and cause the network entity to:
configure a user equipment (UE) with a priority for sidelink discovery messages;
decide, when a conflict occurs between a sidelink discovery message and at least one uplink transmission in a transmission period, whether the UE is to transmit the at least one uplink transmission, based at least in part on the priority for sidelink discovery messages; and
monitor for the at least one uplink transmission in the transmission period, when the decision is that the UE is to transmit the at least one uplink transmission.

12-19. (canceled)

20. An apparatus for wireless communications by a user equipment (UE), comprising:
at least one memory comprising computer-executable instructions; and
one or more processors configured to execute the computer-executable instructions and cause the UE to:
signal a capability of the UE to simultaneously receive, during a reception period, on a downlink and a sidelink; and
receive on the downlink while also receiving on the sidelink, in accordance with the capability.

21. The apparatus of claim 20, wherein the capability is a function of one or more conditions.

22. The apparatus of claim 21, wherein the one or more conditions relate to at least one of:
a received signal power difference between the downlink and the sidelink; or
a difference in subcarrier spacing (SCS) between the downlink and the sidelink.

23. The apparatus of claim 21, wherein the one or more conditions relate to at least one of:
an aligned physical resource block (PRB) grid;
a bandwidth part (BWP) configuration for the downlink; or
a bandwidth part (BWP) configuration for the sidelink.

24. The apparatus of claim 20, wherein the UE supports reduced capability reception on at least one of the downlink or sidelink, when simultaneously receiving on the downlink or sidelink.

25. The apparatus of claim 24, wherein the reduced capability reception involves decoding physical downlink control channels (PDCCHs) with a smaller number of blind decodes (BDs) or control channel elements (CCEs) within an occasion as compared to regular PDCCHs.

26. The apparatus of claim 24, wherein the reduced capability reception involves the UE supporting at least one of:
a reduced downlink control information (DCI) size budget per slot; or
a reduced number of DCIs with pending physical downlink shared channels (PDSCHs) or physical uplink shared channel (PUSCH).

27. The apparatus of claim 24, wherein the reduced capability reception involves the UE monitoring for physical downlink control channels (PDCCHs) on a reduced number of search spaces or control resource sets (CORESETs).

28. The apparatus of claim 24, wherein the one or more processors are further configured to execute the computer-executable instructions and cause the UE to receive signaling configuring the UE with discovery reception gaps for monitoring for sidelink discovery messages from other UEs, wherein the reception period comprises one of the configured discovery reception gaps.

29. The apparatus of claim 28, wherein, during the discovery reception gaps, the UE applies a prioritization between physical uplink shared channel (PUSCH) transmission and discovery reception by comparing a priority of discovery messages to a priority of a PUSCH.

30. The apparatus of claim 28, wherein, during the discovery reception gaps, the UE receives both a discovery message and a physical downlink shared channel (PDSCH).

31. The apparatus of claim 30, wherein the reduced capability reception involves monitoring for PDSCH transmissions based on restrictions on at least one of: a number of resource blocks, a number of layers, a transport block size (TBS), a modulating and coding scheme (MCS), or scheduling PSDCH on a reduced number of carriers.

32. The apparatus of claim 27, wherein:
the UE is configured with at least one semi persistent scheduling (SPS) configuration; and
one or more SPS occasions are skipped during discovery gaps.

33. The apparatus of claim 32, wherein, the UE refrains from sending acknowledgment feedback when one or more SPS occasions are skipped.

34. An apparatus for wireless communications by a network entity, comprising:
at least one memory comprising computer-executable instructions; and
one or more processors configured to execute the computer-executable instructions and cause the network entity to:
receive signaling, from a user equipment (UE), indicating a capability of the UE to simultaneously receive, during a reception period, on a downlink and a sidelink; and
transmit to the UE on the downlink during the reception period, in accordance with the capability.

35-50. (canceled)
